(19) United States
(12) Patent Application Publication
(10) Pub. No.: US 2016/0134963 A1
(43) Pub. Date: May 12, 2016

(54) SPEAKER

(71) Applicant: Cheng Uei Precision Industry Co., Ltd., New Taipei City (TW)

(72) Inventors: Chi Ming Tseng, New Taipei City (TW); Chin Chung Lin, New Taipei City (TW)

(21) Appl. No.: 14/534,997

(22) Filed: Nov. 6, 2014

(51) Int. Cl. H04R 1/28

(52) U.S. Cl. CPC H04R 1/28

(57) ABSTRACT

A speaker includes a speaker enclosure and at least one speaker driver. The speaker enclosure includes an upper housing and a lower housing matched with the upper housing. A bottom face of the upper housing is recessed upward to form a first chamber. The upper housing defines at least one first opening communicating with the first chamber. The speaker driver is fitted in the first opening hermetically. A top face of the lower housing is recessed downward to form a second chamber. The second chamber is interconnected with the first chamber to form an inner chamber in the speaker enclosure. An adjusting assembly is disposed in the second chamber of the lower housing. The adjusting assembly is used to adjust the air volume in the inner chamber by selectively installing a different dimension of the adjusting assembly or a different number of the adjusting assembly.

### BACKGROUND OF THE INVENTION

1. Field of the Invention

The present invention relates to a speaker, and more particularly to a speaker of which the sound effect can be adjusted.

2. The Related Art

A speaker is an electroacoustic transducer which converts an electrical audio signal into a corresponding sound. The speaker is generally consisted of a speaker enclosure and at least one speaker driver housed in the speaker enclosure. The quality of the low frequency sound of the speaker is usually related to the capacity of a sound chamber in the speaker enclosure. In a product development process, the speaker needs to optimize the low frequency sound through testing many different capacity of the sound chamber in the speaker enclosure.

The product development process needs to use numerous speakers to optimize the low frequency sound, as the result, the optimization method defers the development time and increases the cost.

### SUMMARY OF THE INVENTION

Accordingly, an object of the present invention is to provide a speaker. The speaker includes a speaker assembly and an adjusting assembly. The speaker assembly includes a speaker enclosure and at least one speaker driver. The speaker enclosure includes an upper housing and a lower housing matched with the upper housing. A bottom face of the upper housing is recessed upward to form a first chamber. The upper housing defines at least one first opening communicating with the first chamber. The speaker driver is fitted in the first opening hermetically. A top face of the lower housing is recessed downward to form a second chamber. The upper housing and the lower housing are hermetically in one with the second chamber being interconnected with the first chamber to form an inner chamber in the speaker enclosure. The adjusting assembly is disposed in the inner chamber of the speaker enclosure. The adjusting assembly includes a plurality of adjusting shims and a plurality of airtight pads. The adjusting shims are alternately stacked with the airtight pads in the second chamber with uppermost one being the adjusting shim and lowermost one being the airtight pad. Wherein, the adjusting assembly is used to adjust the air volume in the inner chamber by selectively installing a different dimension of the adjusting assembly or a different number of the adjusting assembly in order to adjust the effect of the low-frequency sound of the speaker.

In the present embodiment, when the speaker is in use, the adjusting assembly is used to adjust the air volume in the inner chamber by selectively installing a different dimension of the adjusting assembly or a different number of the adjusting assembly in order to adjust the effect of the low-frequency sound of the speaker for optimizing the reproduction of low-frequency sounds. As described above, the present embodiment of the speaker reduces the development time and decreases the cost.

### BRIEF DESCRIPTION OF THE DRAWINGS

A present of embodiment will be apparent to those skilled in the art by reading the following description, with reference to the attached drawings, in which:

FIG. 1 is a perspective view of a speaker according to an embodiment of the present embodiment;

FIG. 2 is an exploded view of the speaker shown in FIG. 1;

FIG. 3 is another exploded view of the speaker shown in FIG. 1;

FIG. 4 is a perspective view of an upper housing together with speaker drivers and a passive diaphragm etc. of the speaker shown in FIG. 3;

FIG. 5 is a perspective view of an lower housing together with an adjusting assembly etc. of the speaker shown in FIG. 2; and

FIG. 6 is a cross section view of the speaker taken along the VI-VI line shown in FIG. 1.

### DETAILED DESCRIPTION OF THE PREFERRED EMBODIMENT

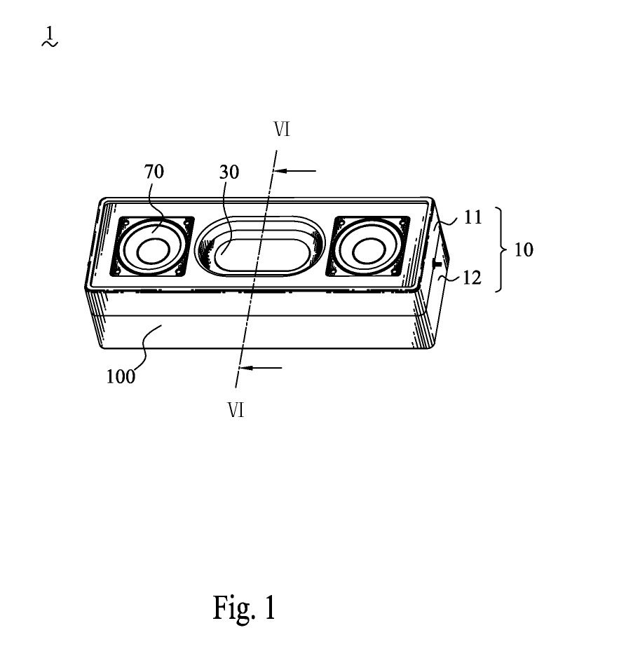

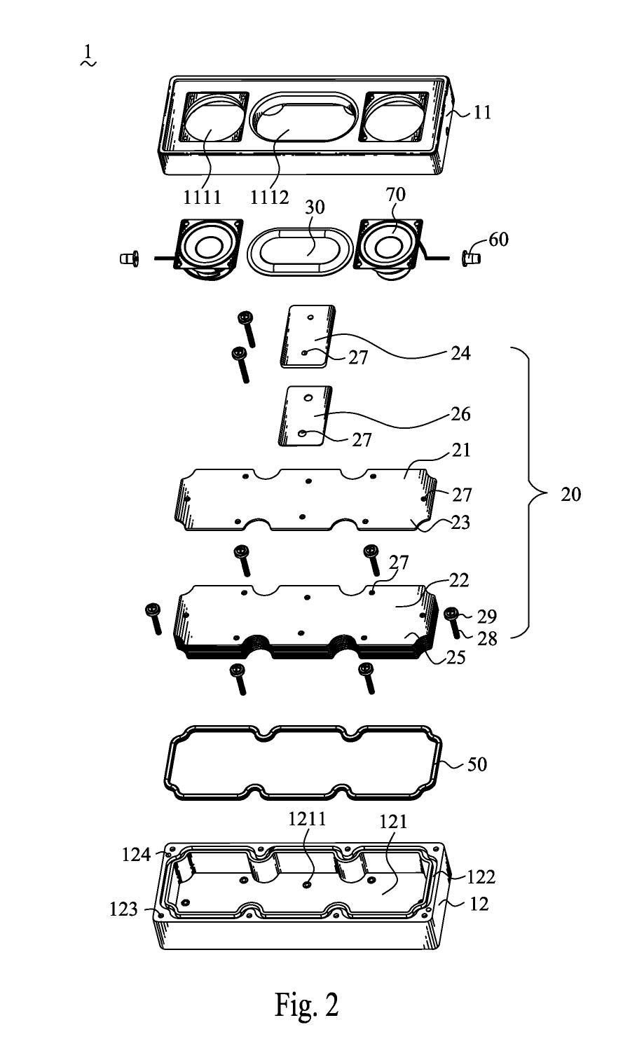

Please refer to FIG. 1 to FIG. 3. A speaker 1 according to an embodiment of the present invention includes a speaker assembly 100 and an adjusting assembly 20. The speaker assembly 100 has a speaker enclosure 10 and at least one speaker driver 70. The speaker driver 70 is fitted to the speaker enclosure 10. The adjusting assembly 20 includes a plurality of adjusting shims 21 and a plurality of airtight pads 22.

Please refer to FIG. 1 to FIG. 3. The speaker enclosure 10 includes an upper housing 11 and a lower housing 12. A bottom face of the upper housing 11 is recessed upward to form a first chamber 111. The bottom face of the upper housing 11 protrudes downward to form an annular rib 112 around the first chamber 111. The bottom face of the upper housing 11 defines a plurality of tapped blind holes 113 arranged along the periphery thereof. The bottom face of the upper housing 11 protrudes downward to form a plurality of positioning pillars 114. The top face of the upper housing 11 defines a first opening 1111 communicating with the first chamber 111. The speaker driver 70 is hermetically fitted in the first opening 1111. The speaker driver 70 and the upper housing 11 are fixed by screw locking. The upper housing 11 further defines a second opening 1112 communicating with the first chamber 111. A passive diaphragm 30 is hermetically installed in the second opening 1112 so as to increase the effect of low frequency sound of the speaker 1.

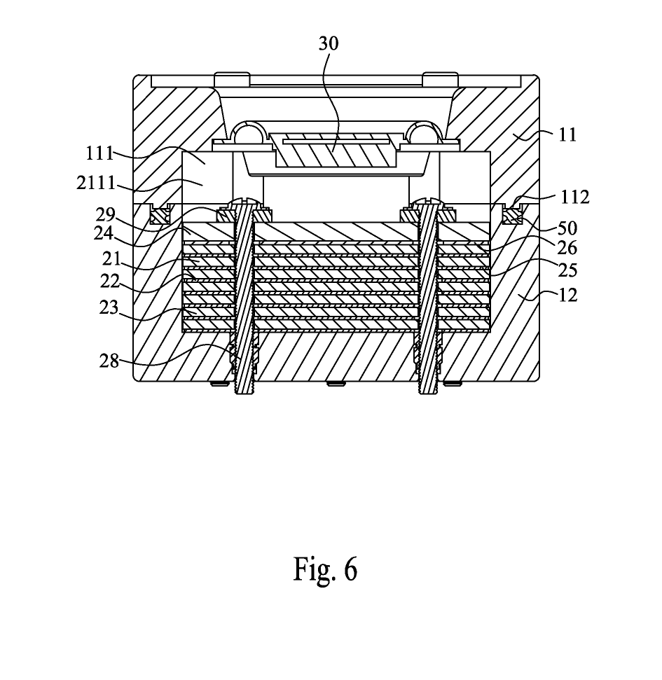

A top face of the lower housing 12 is recessed downward to form a second chamber 121. When the lower housing 12 cooperates to the upper housing 11 hermetically in one, the second chamber 121 of the speaker enclosure 10 is interconnected with the first chamber 111 of the speaker enclosure 10 to form an inner chamber 2111 (shown in FIG. 6) in the speaker enclosure 10. The top face of the lower housing 12 is recessed downward to form a slot 122 around the second chamber 121. The slot 122 receives an airtight gasket 50. The top face of the lower housing 12 defines a plurality of screw through holes 123 arranged in accordance with and connecting with the tapped blind holes 113 respectively. The top face of the lower housing 12 defines a plurality of positioning holes 124 arranged in accordance with the positioning pillars 114 of the upper housing 11.

Please refer to FIG. 1 to FIG. 3. The adjusting assembly 20 is disposed in the inner chamber 2111 of the speaker enclosure 10. In detail, the adjusting shims 21 are alternately stacked with the airtight pads 22 in the second chamber 121 of the lower housing 12 with uppermost one being the adjusting shim 21 and lowermost one being the airtight pad 22. Further, the adjusting shims 21 include a plurality of first adjusting shims 23 and at least one second adjusting shim 24. The second adjusting shim 24 has a smaller dimension than the first adjusting shims 23 and is stacked on top of the first adjusting shims 23. The airtight pads 22 include a plurality of first airtight pads 25 and at least one second airtight pad 26. The second airtight pad 26 has a similar dimension to the second adjusting shim 24 and is stacked on top of the first airtight pads 25 the first adjusting shims 23. The first adjusting shims 23 and the second chamber 121 are in the same shape.

The bottom face of the lower housing 12 defines a plurality of first through holes 1211 communicating with the second chamber 121. The adjusting shims 21 and the airtight pads 22 define a plurality of second through holes 27 interconnecting with one another and vertically in alignment with the first through holes 1211 for equipping with an adjusting screw 28 respectively. An airtight washer 29 is worn around the adjusting screw 28 and positioned between a head end of the adjusting screw 28 and exposed one of the adjusting shims 21.

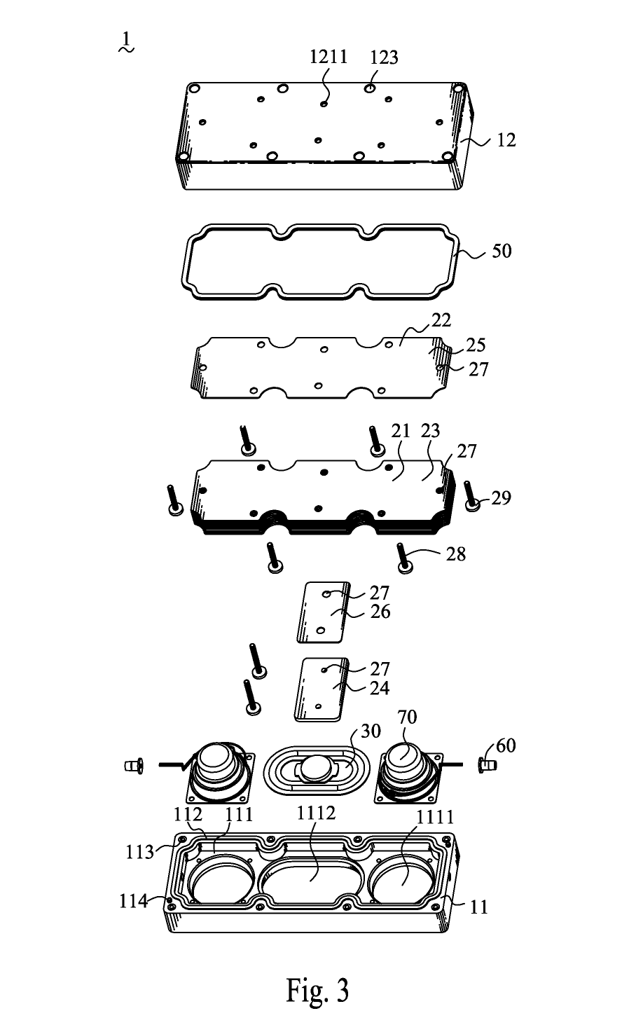

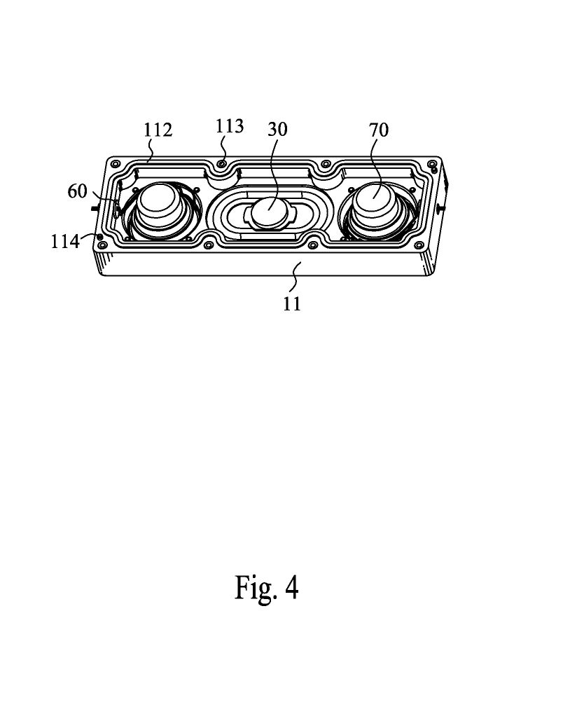

Please refer to FIG. 3 to FIG. 4. The speaker enclosure 10 is further equipped with at least one air tight cable bushing 60. The air tight cable bushing 60 communicates with the inner chamber 2111 and the outside space of the speaker enclosure 10. A wire (not labeled) of the speaker driver 70 is projected to the outside space of the speaker enclosure 10 from the inner chamber 2111 through the air tight cable bushing 60.

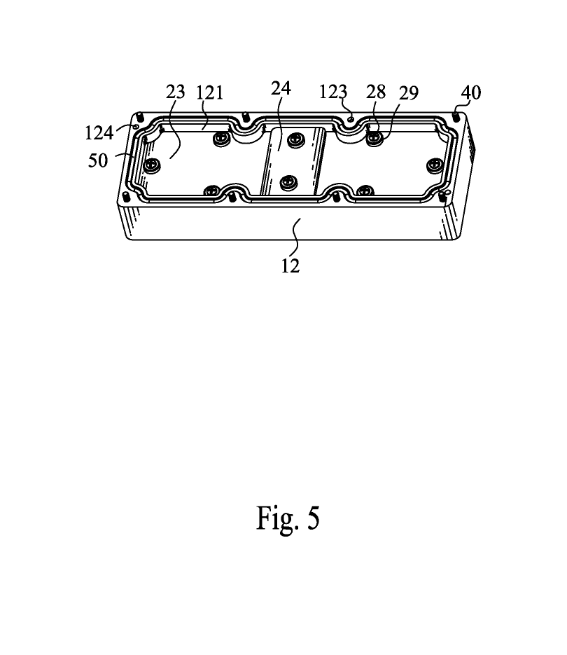

Please refer to FIG. 1 to FIG. 6. In assembly of the speaker 1, when the upper housing 11 is combined with the lower housing 12, the rib 112 is inserted into the slot 122 and pressures the airtight gasket 50 to achieve airtight connection and the positioning pillars 114 are fitted in the positioning holes 124. The upper housing 11 and the lower housing 12 are combined together by a plurality of fastening screws 40 screw-coupling in the screw through holes 123 and the tapped blind holes 113.

In the present embodiment, when the speaker 1 is in use, the adjusting assembly 20 is used to adjust the air volume in the inner chamber 2111 of the speaker enclosure 10 by selectively installing a different dimension of the adjusting assembly 20 or a different number of the adjusting assembly 20 in order to adjust the effect of the low-frequency sound of the speaker 1 for optimizing the reproduction of low-frequency sounds. As described above, the present embodiment of the speaker 1 reduces the development time and decreases the cost.

What is claimed is:

1. A speaker, comprising:
a speaker assembly which includes a speaker enclosure and at least one speaker driver, the speaker enclosure including an upper housing and a lower housing matched with the upper housing, a bottom face of the upper housing being recessed upward to form a first chamber, the upper housing defining at least one first opening communicating with the first chamber, the speaker driver being fitted in the first opening hermetically, a top face of the lower housing being recessed downward to form a second chamber, the upper housing and the lower housing being hermetically in one with the second chamber being interconnected with the first chamber to form an inner chamber in the speaker enclosure; and
an adjusting assembly which is disposed in the second chamber of the lower housing, the adjusting assembly including a plurality of adjusting shims and a plurality of airtight pads, the adjusting shims being alternately stacked with the airtight pads in the second chamber with uppermost one being the adjusting shim and lowermost one being the airtight pad;
wherein the adjusting assembly is used to adjust the air volume in the inner chamber by selectively installing a different dimension of the adjusting assembly or a different number of the adjusting assembly in order to adjust the effect of the low-frequency sound of the speaker.

2. The speaker as claimed in claim 1, wherein the bottom face of the lower housing defines a plurality of first through holes communicating with the second chamber, the adjusting shims and the airtight pads define a plurality of second through holes interconnecting with one another and vertically in alignment with the first through holes for equipping with an adjusting screw respectively, an airtight washer is worn around the adjusting screw and positioned between a head end of the adjusting screw and exposed one of the adjusting shims.

3. The speaker as claimed in claim 1, wherein the adjusting shims includes a plurality of first adjusting shims and at least one second adjusting shim, the second adjusting shim has a smaller dimension than the first adjusting shims and is stacked on top of the first adjusting shims; the airtight pads includes a plurality of first airtight pads and at least one second airtight pad, the second airtight pad has a similar dimension to the second adjusting shim and is stacked on top of the first airtight pads and the first adjusting shims.

4. The speaker as claimed in claim 1, wherein the speaker driver and the upper housing are fixed by screw locking.

5. The speaker as claimed in claim 1, wherein the speaker enclosure is further equipped with at least one air tight cable bushing, the air tight cable bushing communicates with the inner chamber and the outside space of the speaker enclosure, a wire of the speaker driver projects to the outside space of the speaker enclosure from the inner chamber through the air tight cable bushing.

6. The speaker as claimed in claim 1, wherein the bottom face of the upper housing protrudes downward to form a rib around the first chamber, the top face of the lower housing is recessed downward to form a slot around the second chamber, the slot receives an airtight gasket therein, when the upper housing is combined with the lower housing, the rib is inserted into the slot and pressures the airtight gasket to achieve airtight connection.

7. The speaker as claimed in claim 1, wherein the bottom face of the upper housing defines a plurality of tapped blind holes arranged along the periphery thereof, the top face of the lower housing defines a plurality of screw through holes arranged in accordance with and connecting with the tapped blind holes respectively, the upper housing and the lower housing are combined together by a plurality of fastening screws screw-coupling in the screw through holes and the tapped blind holes.

8. The speaker as claimed in claim 1, wherein the bottom face of the upper housing protrudes downward to form a plurality of positioning pillars, the top face of the lower housing defines a plurality of positioning holes arranged in accordance with the positioning pillars of the upper housing, the positioning pillars are fitted in the positioning holes.

9. The speaker as claimed in claim 1, wherein the upper housing further defines a second opening communicating with the first chamber, a passive diaphragm is hermetically installed in the second opening.
